(19) United States
(12) Patent Application Publication
(10) Pub. No.: US 2014/0070827 A1
(43) Pub. Date: Mar. 13, 2014

(54) SYSTEMS AND METHODS FOR COMPENSATED BARRIER PERMEABILITY TESTING

(71) Applicant: Alliance for Sustainable Energy, LLC, Golden, CO (US)

(72) Inventors: Matthew REESE, Golden, CO (US); Arrelaine DAMERON, Boulder, CO (US); Michael KEMPE, Littleton, CO (US)

(73) Assignee: Alliance for Sustainable Energy, LLC, Golden, CO (US)

(21) Appl. No.: 14/026,340

(22) Filed: Sep. 13, 2013

Related U.S. Application Data
(60) Provisional application No. 61/700,677, filed on Sep. 13, 2012.

(51) Int. Cl. G01N 27/04; G01N 15/08

(52) U.S. Cl. CPC G01N 27/048; G01N 15/08
USPC 324/720

(57) ABSTRACT

Systems and methods for compensated barrier permeability testing are provided. In one embodiment, a method for testing water vapor penetration through a barrier material comprises: obtaining a first series of resistance measurements from a first moisture sensor located on a substrate surface of a test card, wherein the first moisture sensor is exposed to a testing chamber sealed onto the substrate surface of the test card; obtaining a second series of resistance measurements from a second moisture sensor, wherein the second moisture sensor is isolated from the testing chamber, wherein the testing chamber is defined by a cavity within a spacer element that separates the first moisture sensor from a test barrier; and determining a measurement of water vapor penetration through the test barrier by adjusting the first series of resistance measurement based on the second series of resistance measurement.

### CROSS-REFERENCE TO RELATED APPLICATIONS

This application claims priority to and benefit of U.S. Provisional Application 61/700,677, entitled “SYSTEMS AND METHODS FOR COMPENSATED BARRIER PERMEABILITY TESTING” filed on Sep. 13, 2012, applicant docket number NREL PROV/12-27, which is incorporated herein by reference in its entirety.

### CONTRACTUAL ORIGIN

The United States Government has rights in this invention under Contract No. DE-AC36-08GO28308 between the United States Department of Energy and the Alliance for Sustainable Energy, LLC, the Manager and Operator of the National Renewable Energy Laboratory.

This is application is related to U.S. patent application Ser. No. 12/842,770, filed on Jul. 23, 2010 and entitled “TEST DEVICE FOR MEASURING PERMEABILITY OF A BARRIER MATERIAL”, which is incorporated herein by reference in its entirety.

### BACKGROUND

The measurement of moisture permeation through barrier materials is a test often performed during the development of thin film barrier materials that are designed to protect flexible electronics. Examples of such flexible electronics include thin film photovoltaics and organic light emitting diodes (OLEDs). One method used to test moisture permeation is the electrical Calcium (Ca) Test. An electrical Ca Test is based on real time measurement of the resistance of Ca films as the Ca within the films changes from being metallic and conductive Ca into an electrically insulating material (Ca(OH)₂) upon reaction with water.

However, other factors besides moisture permeation through the thin film material have been found to affect the real time resistance measurements obtained during electrical Ca testing. These other factors include, but are not limited to, temperature transients, moisture penetration through paths other than the thin film material under test, and interaction of the Ca films with other materials that may leach into the test area. Further, as the Water Vapor Transmission Rate (WVTR) of thin film materials being developed continues to improve, these other factors become more significant in the sense that they can affect the real time measurements to a degree comparable to the water vapor transmission that needs to be measured. While some factors are random and may be statistically addressed, for thin film materials having very low water vapor transmission rates (on the order of 1×10⁻⁴ g/m²/day or less), doing so may increase the testing duration by orders of magnitude. For the reasons discussed above and further discussed below, there is a need in the art for a relatively fast and low cost systems and methods for evaluating low permeation rates for flexible thin-film barrier applications.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The Embodiments described herein, address the problems related to evaluating moisture permeation through thin film materials, as well as other problems and will be understood by reading and studying the following specification. In one embodiment, a method for testing water vapor penetration through a barrier material is provided. The method comprises: obtaining a first series of resistance measurements from a first moisture sensor located on a substrate surface of a test card, wherein the first moisture sensor is exposed to a testing chamber sealed onto the substrate surface of the test card; obtaining a second series of resistance measurements from a second moisture sensor, wherein the second moisture sensor is isolated from the testing chamber, wherein the testing chamber is defined by a cavity within a spacer element that separates the first moisture sensor from a test barrier; and determining a measurement of water vapor penetration through the test barrier by adjusting the first series of resistance measurements based on the second series of resistance measurements.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 is an exploded side view of an embodiment of a moisture penetration test apparatus.

FIG. 2 is a top view of one embodiment of a test card for the moisture penetration test apparatus of FIG. 1.

FIG. 2A is a graph illustrating rate-of-change measurement correction.

FIG. 3 is a cross-sectional view at “A-A” of one embodiment of the moisture penetration test apparatus of FIGS. 1 and 2.

FIGS. 3A to 3D are cross-sectional views of various alternative embodiments for a moisture penetration test apparatus.

FIG. 4 is a diagram illustrating a function of a spacer element or one embodiment of a moisture penetration test apparatus.

FIG. 5 is a block diagram illustrating an example embodiment of a moisture barrier testing system.

FIG. 6 are graphs illustrating an example of moisture barrier testing data for a moist barrier testing system.

FIG. 7 is a flow chart illustrating an embodiment for a method for testing water vapor penetration through a barrier material.

In accordance with common practice, the various described features are not drawn to scale but are drawn to emphasize relevant features. Reference characters denote like elements throughout Figures and text.

### DETAILED DESCRIPTION

Embodiments of the present disclosure provide for relatively fast and low cost systems and methods for evaluating low permeation rates for flexible thin-film electronic applications by providing for a high accuracy witness sensor embedded within a moisture test apparatus, in addition to one or more moisture sensors. In one embodiment, the witness sensor is comprised of the same material as the moisture sensors, and positioned within the moisture test apparatus such that the witness sensor will experience a similar set of factors experienced by the moisture sensors, without being exposed to moisture from water vapor permeation through the thin film material being tested. By contemporaneously capturing real time resistance measurement data sets from both a moisture sensor and the witness sensor, data from the witness sensor can be correlated with corresponding data from the moisture sensor to identify changes in moisture sensor resistance directly attributable to water vapor permeation through the thin film material being tested.

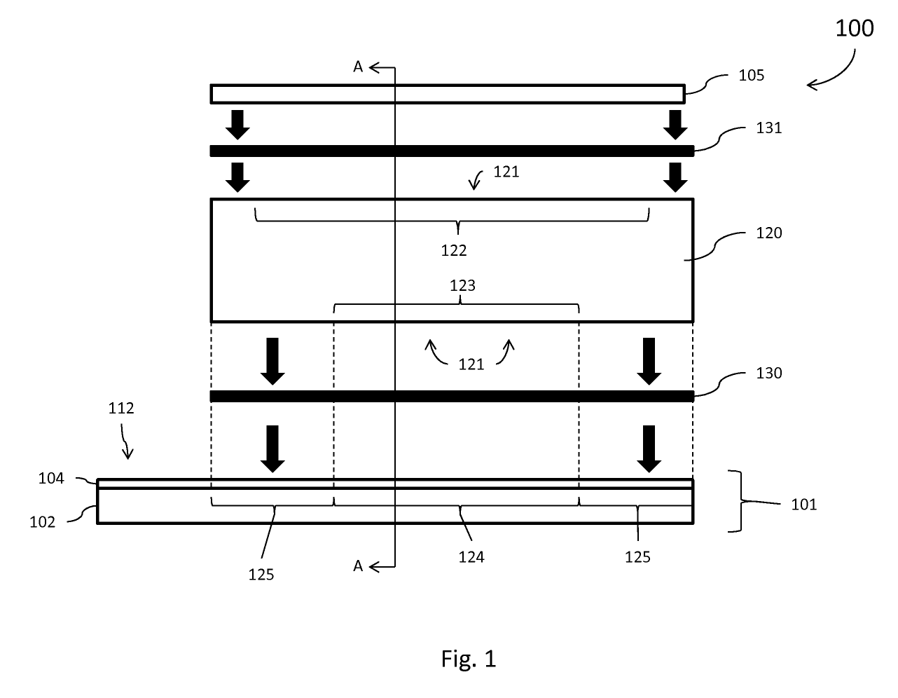

FIG. 1 is an exploded view diagram of a moisture penetration test apparatus of one embodiment of the present disclosure, shown generally at 100. Moisture penetration test apparatus 100 comprises a test card 101, a spacer element 120, a seal material 130 which couples test card 101 to spacer element 120, and a seal material 131 which couples spacer element 120 to a barrier 105 being tested, such as but not limited to a thin film barrier material. Spacer element 120 includes a first opening 122 (referred to herein as test aperture 122) and an opposing second opening 123 (referred to herein as sensing aperture 123) which are connected within spacer element 120 by an open region referred to herein as testing chamber 121. In operation, in one embodiment, spacer element 120 is configured such that a barrier 105 being tested is sealed over test aperture 122. Spacer element 120 is affixed in place onto test card 101, such that the interface between sensor aperture 123 and test card 101 defines a sensing region 124 of test card 101 that is directly exposed to the testing chamber 121. In operation, moisture penetrating barrier 105 will pass through test aperture 122 and into testing chamber 121 and collect onto sensing region 124. The surface region of test card 101 that is external to sensing region 124 and physically bonded by seal material 130 to spacer element 120 is referred to herein as seal region 125. As explained in further detail below, test card 101 comprises a layer of sensors and electrical traces 104 formed upon a substrate layer 102. The layer 104 of sensors and electrical traces includes one or more moisture sensors located within sensing region 124, as well as at least one witness sensor located within seal region 125.

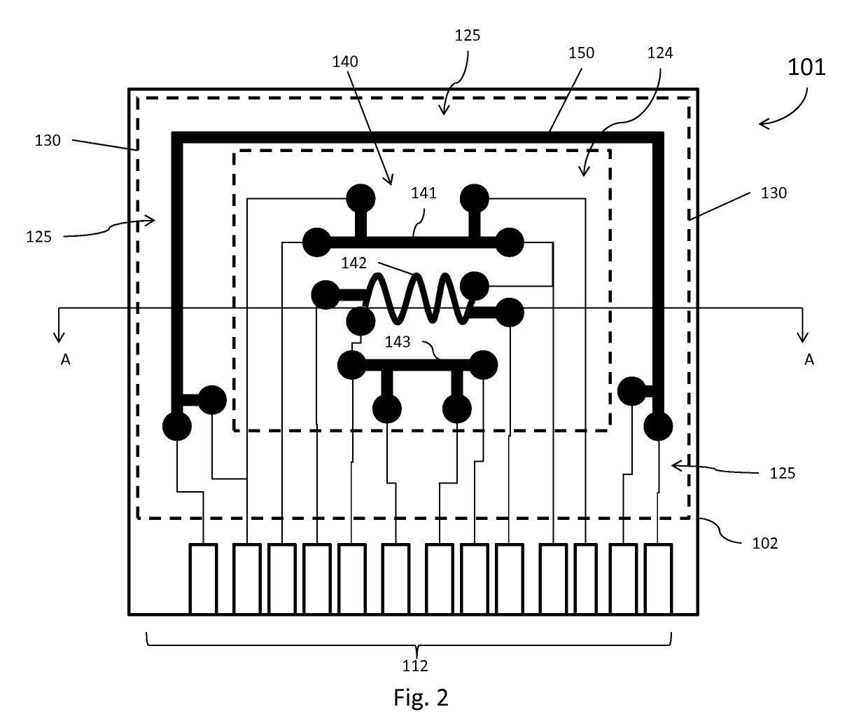

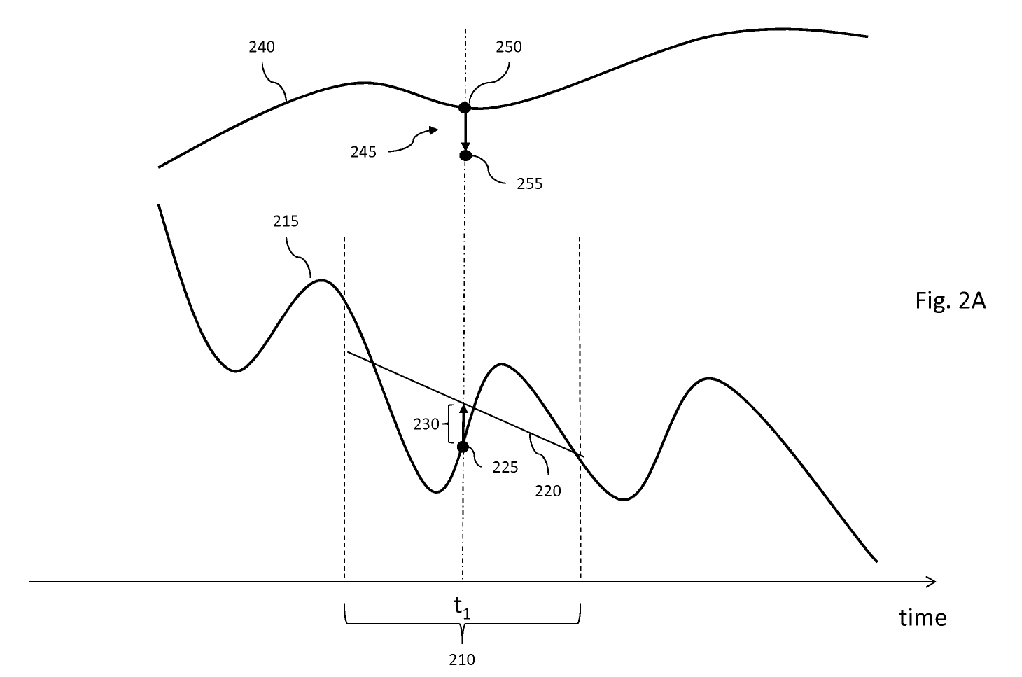

FIG. 2 is a diagram illustrating a top view of one embodiment of a test card 101. Test card 101 comprises one or more 4-wire resistive moisture sensors 140 positioned within sensing region 124 of test card 101 such that the moisture sensors 140 are exposed to the interior of testing chamber 121. Test card 101 also comprises at least one 4-wire resistive witness sensor 150 positioned within seal region 125 of test card 101 such that witness sensor 150 is sandwiched between seal material 130 and test card 101 and not exposed to testing chamber 121 nor to conditions external to apparatus 100. A series of non-reactive electrical connections 112 provide electrical connectivity for both moisture sensors 140 and witness sensor 150 to external measurement devices. In some embodiments, one or more of the connections 112 may be shared between sensors to reduce the number of connections 112 needed and making management of test connections to test card 101 easier.

In the particular embodiment illustrated by test card 101, both moisture sensors 140 and witness sensor 150 are Calcium (Ca) sensors deposited onto substrate 102 using the same procedures and same materials. That is, other than their physical shapes and locations on the surface of test card 101, moisture sensors 140 and witness sensor 150 are equivalent Ca sensors from a material perspective. When exposed to the same conditions, sensors 140 and 150 should react similarly. As would be appreciated by one of ordinary skill in the art after reading this specification, Ca sensors react in the presence of moisture to transform from metallic, conductive Ca to electrically insulating Ca(OH)₂. As this reaction occurs, the electrical resistance of the Ca sensor increases as a function of the amount of moisture to which the sensor is exposed. In other embodiments, moisture sensors comprising materials other than Ca may be utilized for moisture sensors 140 and witness sensor 150.

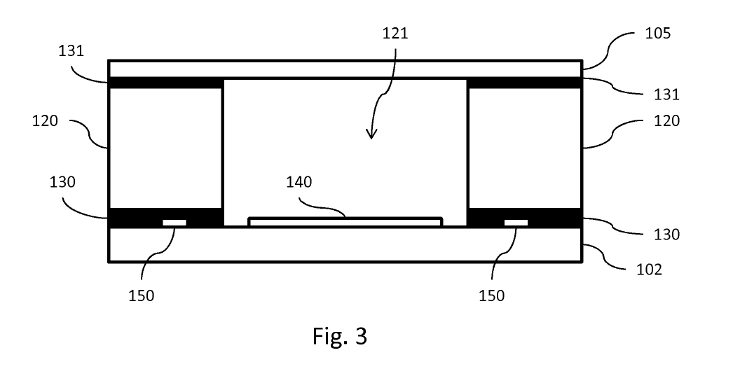

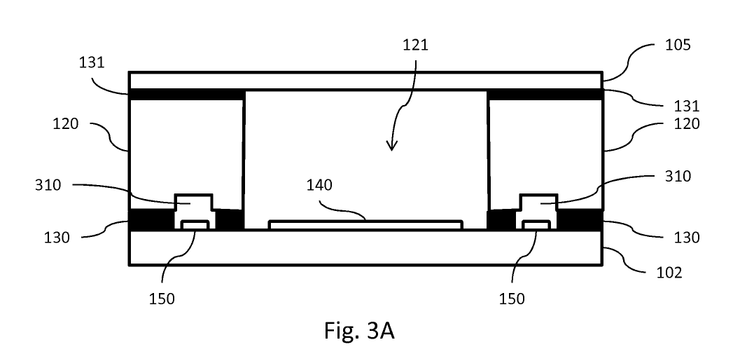

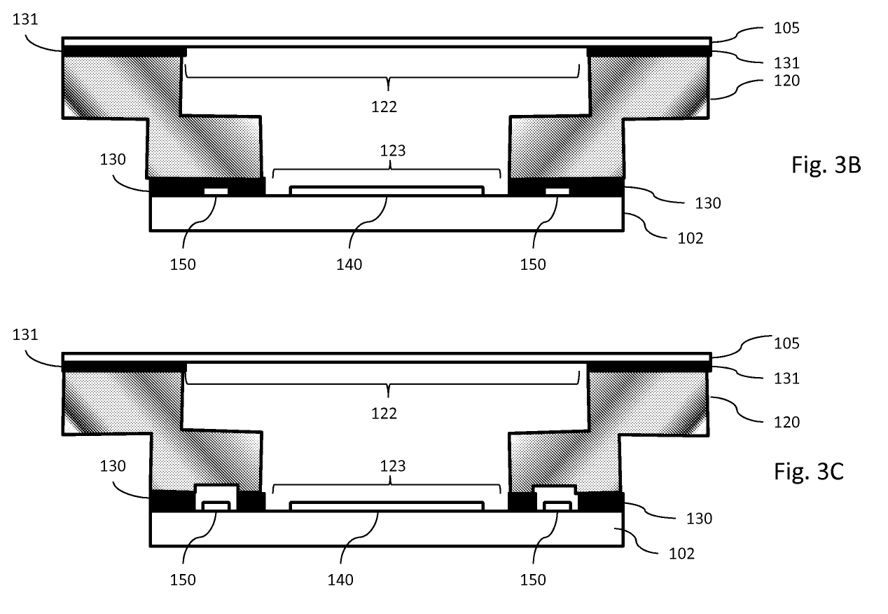

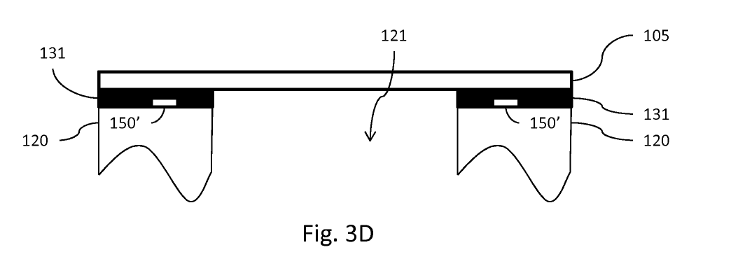

FIGS. 3 and 3A-3D illustrate cross-sectional view “A-A” of different example embodiments of the apparatus 100 shown in FIGS. 1 and 2. One of ordinary skill in the art upon reading this disclosure would appreciate that the figures provided herein are not draw to scale, but are instead drawn to better emphasize relevant features. As illustrated in FIG. 3, moisture sensors 140 are exposed directly to the interior of testing chamber 121, while witness sensor 150 is isolated from testing chamber 121. In this configuration, witness sensor 150 is located within apparatus 100, on the same substrate as sensors 140, and exposed to the same fluctuations in testing conditions as sensors 140 (other than being exposed to testing chamber 121). As a direct consequence, this means that test parameters, phenomena or other fluctuating conditions that concurrently affect both the measurement data obtained from moisture sensors 140 and witness sensor 150 most likely represent something other than the penetration of moisture through barrier 105 into testing chamber 121.

For example, fluctuations in the resistance of a Ca sensor can be caused by temperature changes. If changes in resistance measurements from moisture sensors 140 are due to temperature and moisture, and changes in resistance measurements from witness sensor 150 are due to temperature, but not moisture, then the resistance data from witness sensor 150 may be used to adjust the resistance measurements from moisture sensors 140 to compensate for temperature fluctuations. Similarly, resistance measurements from witness sensor 150 can be used to adjust resistance measurements from moisture sensors 140 to compensate for a myriad of other factors, some of which may not be completely understood or identified. For example, there are reactions that can take place between the Ca in sensors 140 and 150 and the substrate 102 of test card 101. Where substrate 102 is fabricated from glass, impurities or other elements can leach out of the glass over time and react with the Ca of sensors 140 and 150. To the degree that such leaching is roughly uniform over the surface of test card 101, sensors 140 and 150 will be similarly affected. Therefore, changes in resistance measured by witness sensor 150 may be used to correlate changes in resistance measured by moisture sensors 140 in order to compensate for anomalous noise such as leaching elements out of the substrate, reaction with the substrate, annealing of the Ca sensor lines, or other sources of noise.

For applications where a reaction between seal material 130 and witness sensor 150 may be of a concern, FIG. 3A illustrates an alternate embodiment of apparatus 100 that includes a sealed witness sensor chamber 310 formed within spacer element 120 and seal material 130. In this embodiment, witness sensor 150 is located within witness sensor chamber 310, isolated from both testing chamber 121 and the external environment of apparatus 100, but also not in contact with seal material 130.

In general, measurement data from witness sensor 150 provides baseline data that can be used to adjust measurements from sensors 140. Although in some embodiments, measurement data from witness sensor 150 may be directly used to correct measurement data from measurement sensors 140, in other embodiments, calculating a compensation factor is achieved in other ways. The raw measurement data from one or both of sensors 140 and 150 can be normalized and/or converted into rate-of-change data, for instance. Further, compensation of the measurements from sensors 140 may be based on a weighted function to address factors such as geometry. For example, as illustrated in FIG. 2, measurement sensors 140 may include individual measurement sensors (such as 141, 142 and 143) of differing lengths, thicknesses and shapes. These different geometries dictate the total surface area of each sensor, which in turn will affect exactly how each sensor precisely responds to moisture and environmental fluctuations. Similarly, witness sensor 150 will respond to environmental fluctuations as a function of its own geometry. Accordingly, resistance measurement data from one or both of measurement sensors 140 and witness sensor 150 may be weighed, normalized or otherwise adjusted to obtain a compensated measurement data set that primarily represent moisture penetration through barrier 105.

For example, in one normalized witness sensor resistance measurement approach the witness sensor is presumed to have a constant resistance over the time of the entire test. For a gross approximation, this makes sense because the witness sensor 150 is sealed within an encapsulant (e.g., material 130) or otherwise segregated from the moisture within testing chamber 121 (such as the sealed witness chamber sensor 310). If the resistance data from the witness sensor 150 decreases by a percentage (e.g., x %) from the initial baseline resistance data, that deviation from the baseline can be used to increase the test data from measurement sensors 140 by that same percentage. That is, if the initial baseline resistance of the witness sensor 150 at time t₀ is normalized to 1, and a normalized witness sensor data sample at time t₁ is measured (to be 0.95 for example), then the test data from a sensor 140 taken an time t₁ can be corrected by increasing its value proportionally to the change in the witness sensor (e.g., by dividing the test data by 0.95). In this way, a point-by-point correction of sensor 140 measurement data is performed based on the deviation of the corresponding witness data at that point in time from its initial value.

As previously mentioned, however, even though ideally the witness sensor 150 itself should not degrade from moisture exposure over the course of testing, in practice its resistance may still change and drift over time due to contamination from material 130 or substrate 102 or for other reasons. To account for resistance drift in the witness sensor 150, a rate-of-change approach (also referred to as slope-correction), may be used that does not presume a constant witness sensor 150 resistance over the time, such as illustrated in FIG. 2A. Using rate-of-change, a window of time 210 that includes witness data 215 from both sides of a witness data test point 225 at t₁ is defined. Based on the witness data 215 within that window 210, a witness line 220 having a calculated sloped is computed through the witness data 215. The witness line 220 will also have a center point within the window of time 210 that is based on the average value of the witness data 215 within the window 210. Then the deviation 230 of witness data test point 225 at t₁ from the computed witness line 220 at t₁ can be used to proportionally correct the test data 240 from sensor 140 taken at t₁. As shown generally at 245, the rate-of-change approach presumes that measurement data 240 from the moisture sensors 140 taken at t₁ (illustrated by point 250) will change proportionally to the deviation 230 of the corresponding point 225 from the calculated witness line 220 and corrects the data from the moisture sensor 140 from point 250 to point 255 proportionally.

It is contemplated that the slope of the computed witness line will be, at least in part, a function of the material used for fabrication substrate 102 and/or seal material 130. For example, increasing conductivity of a witness sensor 150 during the course of a test may be reduced by moving away from using a soda lime glass for substrate 102 in favor of a silica or borosilicate material. Generally, substrate materials with fewer mobile ions are less likely to have those ions leach out of the substrate into the witness sensor 150. Thus it is proposed that the selection of substrate 102 material may impact the width of the window of time such that materials that exhibit relatively less leaching of contaminants into witness sensor 150 could utilize relatively shorter windows. In turn, relatively shorter windows permit quicker calculation of corrections to moisture sensor 140 data because fewer witness data points are needed to calculate the witness line. As such, the process in some implementations can converge on near real time corrections to moisture sensor 140 data, which may be advantageous for industrial applications. However, to be able to accurately account for general trends in the witness data, the window of time used to calculate the witness line should be sufficiently long to account for periodic or non-periodic testing environment fluctuations. Substrate materials with fewer mobile ions should also make normalized point-to-point corrections more correct with less need for slope correction, making the windows less of an issue, hence less overall time.

FIGS. 3B and 3C illustrate alternate embodiments of moisture penetration test apparatus 100 where the area ratio of test aperture 122 to sensing aperture 123 is other than 1:1. By varying the ratio of these areas, the sensitivity of measurement sensors 140 to moisture penetration through barrier 105 can be controlled. For example, by increasing the area of test aperture 122 relative to sensing aperture 123, testing chamber 121 will collect moisture penetration from a relatively larger area of barrier 105 and a greater amount of total moisture will reach sensing aperture 123 and measurement sensors 140. This increases the sensitivity of measurement sensors 140 with respect to measuring the moisture penetration qualities of barrier 105. FIG. 3D illustrates another alternate embodiment illustrating an upper portion of an apparatus 100 (such as but not limited to any of those described herein) where a witness sensor (shown as 150′) is located between barrier 105 and spacer element 120 either instead of, or in addition to, witness sensor 150. That is, witness sensor 150′ performs the same function and has the same characteristics as witness sensor 150, and is isolated from chamber 121, but is instead positioned between barrier 105 and spacer element 120.

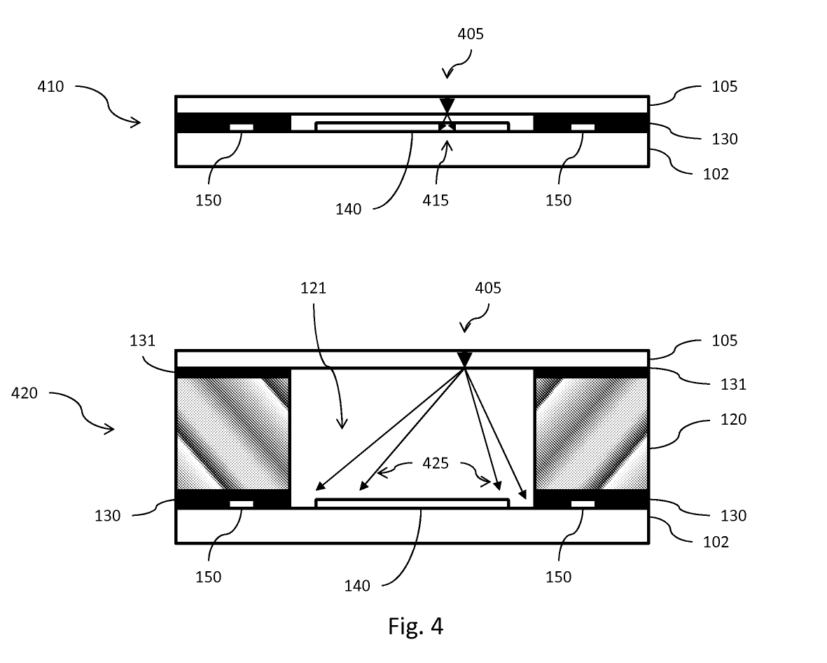

FIG. 4 provides another illustration of how the geometry of spacer element 120 may affect the sensitivity of measurement sensors 140 to moisture penetration through barrier 105. Shown generally at 410 is a configuration where barrier 105 is coupled to test card 101 such that there is a negligible, or no, distance between barrier 105 and moisture sensors 140. In this configuration, when there is a localized point of moisture penetration through barrier 105 (such as shown at 405), the moisture that does penetrate is almost entirely concentrated onto a small localized region of the moisture sensors 140 (shown at 415), causing a reaction with the Ca that rapidly increases the resistance of the total sensor disproportionately given the total amount of water vapor to which the sensor has been exposed as a whole. As shown generally at 420, spacer element 120 provides a distance between the localized point of moisture penetration 405 and moisture sensors 140 which allows the penetrating moisture to spatially diffuse within testing chamber 121 (as shown at 425). Moisture sensors 140 therefore react with the moisture more uniformly across their entire area, which results in finer changes in sensor resistance and higher resolution measurement data.

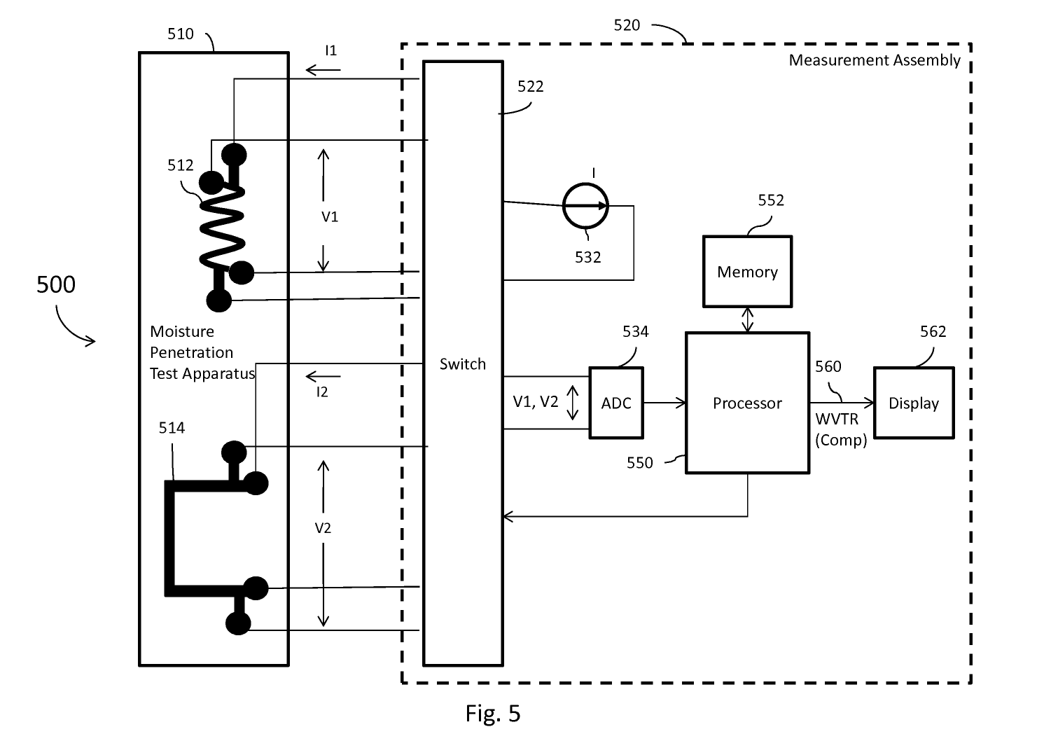

FIG. 5 is a schematic diagram illustrating an example embodiment of a moisture barrier testing system 500. Moisture barrier testing system 500 includes a moisture penetration test apparatus 510 having at least one 4-wire resistive moisture sensor 512 and at least one 4-wire witness sensor 514. For the purpose of providing this example, moisture penetration test apparatus 510 may be implemented using the moisture penetration test apparatus 100 described above. That is, moisture barrier testing system 500 may be implemented using any combination or variation of configurations described above with respect to moisture penetration test apparatus 100, or alternately using another moisture penetration test apparatus.

Moisture barrier testing system 500 further includes a measurement assembly 520 coupled to moisture penetration test apparatus 510. Measurement assembly 520 comprises a current source 532 and an analog-to-digital converter (ADC) 534. In the embodiment shown in FIG. 5, the measurement assembly 520 is selectively coupled in a 4-wire resistance test configuration to moisture sensor 512 and witness sensor 514 via switch 522. In operation, switch 522 is operated by processor 550 to sequence through the sensors (512, 514) to effectively multiplex measurement data from the sensors onto different respective logical channels. For example, during a first time interval, switch 522 is operated such that current source 532 supplies a known first current (shown at I1) through moisture sensor 512. Current I1 generates a voltage V1 across sensor 512 that varies as a function of moisture sensor 512 resistance. The analog voltage V1 is coupled to ADC 534, which outputs a set of moisture sensor measurement data that represents the resistance of moisture sensor 512. During a second time interval, switch 522 is operated such that current source 532 supplies a known second current (shown at I2) through witness sensor 514. Current I2 generates a voltage V2 across sensor 514 that varies as a function of witness sensor 514 resistance. The analog voltage V2 is coupled to ADC 534, which outputs a set of moisture sensor measurement data that represents the resistance of witness sensor 514. Although element 522 is described as a “switch,” this is not intended to imply that it must be implemented using a mechanical switch. Instead, switch 522 may be implemented, for example, by an integrated circuit, or other digital logic or multiplexing device. In one embodiment, the measurement assembly may be implemented using a multichannel digital multi-meter or scope that inputs measurements from the sensors on different input terminals and records those measurements as different logical channels.

In the particular embodiment shown in FIG. 5, Measurement assembly 520 comprises a processor 550 that is programmed to generate an output of witness compensated data (such as Water Vapor Transmission Rate (WVTR) data 560, for example) by adjusting moisture sensor measurement data using the witness sensor measurement data. For example, in one embodiment, processor 550 receives moisture sensor measurement data and witness sensor measurement data and stores the two sets of data into a memory 552. Then, in order to calculate witness compensated Water Vapor Transmission Rate (WVTR) data 560, processor 550 retrieves from memory 552 moisture sensor measurement data and witness sensor measurement data for a given time interval, adjusts the moisture sensor measurement data based on the witness sensor measurement data (as discussed with respect to any of the embodiments of FIG. 1-4) and calculates a WVTR from the difference to produce the compensated WVTR data 560. In one embodiment, either one or both of the moisture sensor measurement data and the witness sensor measurement data may be time averaged, weighted, or otherwise statistically adjusted before the WVTR data 560 is calculated. In one embodiment, WVTR data 560 may be provided to a display 562 to observe the moisture penetration performance for the barrier material being tested.

As would be appreciated by one of ordinary skill in the art after reading this disclosure, as measurement of rate, a WVTR may be empirically determined based on changes in resistance values from one data sample to the next. As such, the reliability of a calculated WVTR data point is dependent on how much one can believe that a change in measured resistance is attributable to moisture penetration and not due to other factors. Using embodiments disclosed herein, the witness compensated WVTR data 560 will provide an accurate representation of the WVTR for barrier 105 with factors other than water vapor penetration substantially removed. This compensation enables the collection of highly accurate WVTR data for barrier materials with very low moisture permeability.

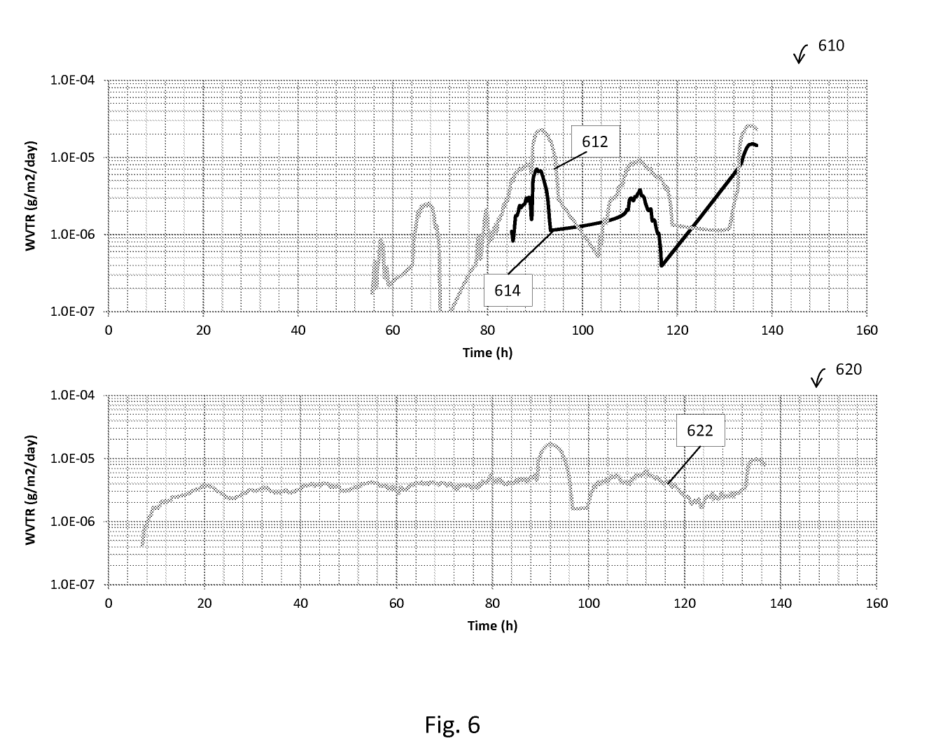

FIG. 6 provides a set of graphs (shown at 610 and 620) plotting WVTR data based on resistance measurements collected by a test setup such as depicted by FIG. 5. Graph 610 depicts WVTR data (shown by plot 612) derived from resistance values directly measured from moisture sensor 512, without compensation from resistance values from witness sensor 514 (shown by plot 614). Graph 620 depicts compensated WVTR data (shown by plot 622) derived from the same resistance values measured from moisture sensor 512 used in graph 610. However, those resistance values are adjusted with respect to normalized resistance values from witness sensor 514 before the WVTR is calculated. As is evident by comparing plot 612 to plot 622, compensated WVTR data tends to remain within the range of an order of magnitude (i.e. 1×10⁻⁵ g/m²/day to 1×10⁻⁶ g/m²/day) while non-compensated WVTR data, even after steady state testing of many hours, wanders over a much larger range (i.e., 1.6×10⁻⁴ g/m²/day to 1.9×10⁻⁷ g/m²/day).

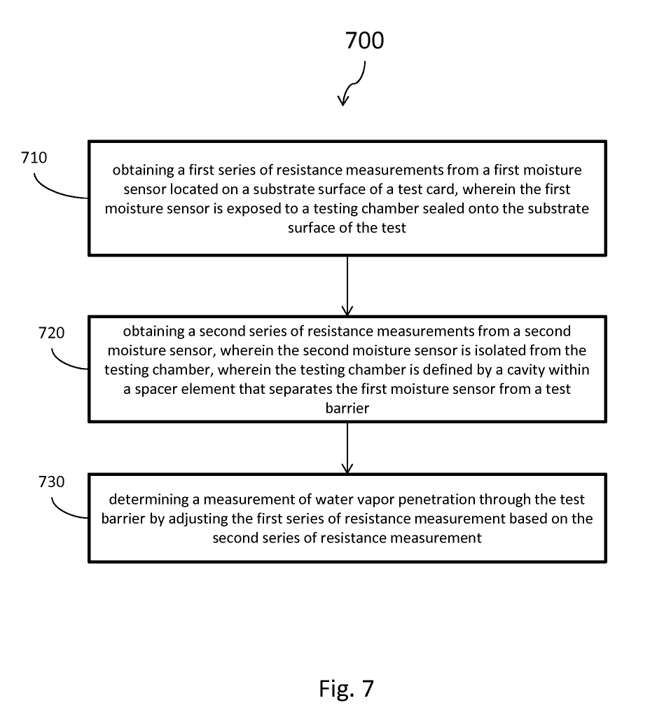

FIG. 7 is a flow chart illustrating at 700 a method embodiment for testing water vapor penetration through a barrier material. In alternate embodiments, method 700 may be implemented using any of the embodiments described above or combinations thereof. The method begins at 710 with obtaining a first series of resistance measurements from a first moisture sensor located on a substrate surface of a test card, wherein the first moisture sensor is exposed to a testing chamber sealed onto the substrate surface of the test card. The method further includes 720, obtaining a second series of resistance measurements from a second moisture sensor located on the substrate surface of the test card, wherein the second moisture sensor is isolated from the testing chamber, wherein the testing chamber is defined by a cavity within a spacer element that separates the first moisture sensor from a test barrier. Steps 710 and 720 may be performed concurrently or sequentially in either order.

In the particular embodiment illustrated by test card 101, the first moisture sensor and the second moisture sensor are both sensors deposited onto the substrate using the same procedures and same materials. That is, other than their physical shapes and locations on the substrate surface of the test card, the first and second moisture sensors are equivalent sensors from a material perspective meaning that when they are exposed to the same conditions, the sensors should react similarly. In one embodiment, the first and second moisture sensors are both Ca sensors that react in the presence of moisture to transform from metallic, conductive Ca to electrically insulating Ca(OH)₂. As this reaction occurs, the electrical resistance of the Ca sensor increases as a function of the amount of moisture to which the sensor is exposed. In other embodiments, moisture sensors comprising materials other than Ca may be utilized.

Both the first and second moisture sensors are fabricated onto the same substrate and exposed to the same fluctuations in testing conditions with the exception that the first moisture sensor is exposed to the testing chamber while the second moisture sensor is isolated from the testing chamber. As described in greater detail above, this means that test parameters, phenomena or other fluctuating conditions that concurrently affect both the resistances of both moisture sensors represent something other than the penetration of moisture through the test barrier into the testing chamber. Therefore, fluctuations measured by the second moisture sensor may be subtracted from changes in resistances measured by the first moisture sensor in order to better identify changes in the first moisture sensor resistance due to moisture penetration of the test barrier.

Accordingly, the method proceeds to 730 with determining a measurement of water vapor penetration through the test barrier by adjusting the first series of resistance measurement based on the second series of resistance measurement. For example, in one embodiment, the method comprises receiving first and second moisture sensor measurement data and for a given time interval, applying an adjustment calculated from the second moisture sensor measurement data to the first moisture sensor measurement data to calculate a compensated transmission statistic, such as a WVTR. In one embodiment, either one or both sets of moisture sensor measurement data may be time averaged, weighted, or otherwise statistically adjusted before the WVTR is calculated.

Several means are available to implement the testing systems and methods such as described above. These means include, but are not limited to, processing hardware such as digital computer systems, programmable controllers or testing equipment, or field programmable gate arrays. Therefore other embodiments include programmable instructions resident on physically non-transient computer readable media which when implemented by such processing hardware, enable the hardware to implement various embodiments. Computer readable media include any form of physically non-transient storage devices, including but not limited to magnetic disk or tape, punch cards, CD and/or DVD devices, or any optical data storage system, flash ROM, non-volatile ROM, or RAM.

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

What is claimed is:

1. A method for testing water vapor penetration through a barrier material, the method comprising:
obtaining a first series of resistance measurements from a first moisture sensor located on a substrate surface of a test card, wherein the first moisture sensor is exposed to a testing chamber sealed onto the substrate surface of the test card;
obtaining a second series of resistance measurements from a second moisture sensor, wherein the second moisture sensor is isolated from the testing chamber, wherein the testing chamber is defined by a cavity within a spacer element that separates the first moisture sensor from a test barrier; and
determining a measurement of water vapor penetration through the test barrier by adjusting the first series of resistance measurements based on the second series of resistance measurements.

2. The method of claim 1, wherein the second moisture sensor is located either:
on the substrate surface of the test card;
internal to the spacer element; or
sealed within a seal material between the test barrier and the spacer element.

3. The method of claim 1, further comprising:
determining an integrity of a seal material between the spacer element and the test card based on the second series of resistance measurements.

4. The method of claim 1, wherein the second moisture sensor is sandwiched between the spacer element and the test substrate surface;
wherein the second moisture sensor is sealed within a witness chamber formed within the spacer element; and
wherein the spacer element comprises a first aperture sealed by the test barrier and a second aperture sealed by the test card.

5. The method of claim 1, wherein the first resistance measurement is calculated from a plurality of measurement samples collected from the first moisture sensor; and
wherein the second resistance measurement is calculated from a plurality of measurement samples collected from the second moisture sensor.

6. The method of claim 1, wherein the adjustment is calculated at least in part from a geometry of the first moisture sensor and a geometry of the second moisture sensor.

7. The method of claim 1, wherein the first moisture sensor and the second moisture sensor are both Calcium moisture sensors.

8. The method of claim 1, wherein the first moisture sensor and the second moisture sensor are fabricated from the same material.

9. The method of claim 1, further comprising:
applying a known current through the second moisture sensor and reading a voltage across the second moisture sensor to obtain a compensation factor for adjusting the first series of resistance measurements.

10. The method of claim 1, wherein adjusting the first series of resistance measurements based on the second series of resistance measurement further comprises:
calculating a compensation factor based on normalizing measurement data from the second series of resistance measurements.

11. The method of claim 1, wherein adjusting the first series of resistance measurements based on the second series of resistance measurement further comprises:
calculating a compensation factor based on a rate-of-change analysis applied to the second series of resistance measurements.

12. An apparatus for testing water vapor penetration through a barrier material, the apparatus comprising:
a spacer element having a first chamber that connects a first aperture of the spacer element to a second aperture of the spacer element;
a test card comprising a substrate with at least one moisture sensor deposited onto a surface of the substrate, and a witness sensor deposited onto the surface of the substrate, wherein the spacer element is sealed to the test card by a seal material such that the at least one moisture sensor is exposed to the first chamber through the second aperture, and the witness sensor is isolated from the first chamber;
the test card further including:
a first set of electrical connections coupled to the at least one moisture sensor; and
a second set of electrical connections coupled to the witness sensor.

13. The apparatus of claim 12, wherein one or both of the first set of electrical connections and the second set of electrical connections have a four-wire configuration.

14. The apparatus of claim 12, wherein the first sensor and the second sensor are both Calcium moisture sensors.

15. The apparatus of claim 12, wherein the first sensor and the second sensor are fabricated from the same material.

16. The apparatus of claim 12, further comprising:
a test barrier material that seals the first aperture.

17. The apparatus of claim 12, the spacer element further comprising a second chamber isolated from the first chamber, wherein the witness sensor is located within the second chamber.

18. A system for testing water vapor penetration through a barrier material, the system comprising:
a moisture penetration apparatus comprising:
a first moisture sensor located on a substrate surface of a test card, wherein the first moisture sensor is exposed to a testing chamber sealed onto the substrate surface of the test card; and
a second moisture sensor located on the substrate surface of the test card, wherein the second moisture sensor is isolated from the testing chamber, wherein the testing chamber is defined within a spacer element that separates the first moisture sensor from a test barrier; and
a measurement assembly coupled to the moisture penetration test apparatus, wherein the measurement assembly is configured to determine a measurement of water vapor penetration through the test barrier by adjusting the first series of resistance measurements based on the second series of resistance measurements.

19. The system of claim 18, the test card further including:
a first set of electrical connections coupled to the first moisture sensor; and
a second set of electrical connections coupled to the second moisture sensor.

20. The system of claim 18, wherein the second moisture sensor is sandwiched between the spacer element and the test substrate surface; and
wherein the second moisture sensor is sealed within a witness chamber formed within the spacer element.

21. The system of claim 18, wherein the measurement assembly processes a first plurality of measurement samples collected from the first moisture sensor to calculate the first resistance measurement; and
wherein the measurement assembly processes a second plurality of measurement samples collected from the second moisture sensor to calculate the second resistance measurement.

22. The system of claim 18, wherein the first sensor and the second sensor are both Calcium moisture sensors.

23. The system of claim 18, wherein the first sensor and the second sensor are fabricated from the same material.

24. The system of claim 18, wherein the measurement assembly applies a known current through the second moisture sensor and reads a voltage across the second moisture sensor to obtain a compensation factor for adjusting the first series of resistance measurements.

25. The system of claim 18, wherein the measurement assembly stores compensated water vapor penetration data into a memory.

26. The system of claim 18, wherein adjusting the first series of resistance measurements based on the second series of resistance measurements further comprises:
calculating a compensation factor based on normalizing measurement data from the second series of resistance measurements.

27. The system of claim 18, wherein adjusting the first series of resistance measurements based on the second series of resistance measurements further comprises:
calculating a compensation factor based on a rate-of-change analysis applied to the second series of resistance measurements.
